(19) United States
(12) Patent Application Publication
(10) Pub. No.: US 2008/0284717 A1
(43) Pub. Date: Nov. 20, 2008

(54) ELECTRO-OPTICAL DEVICE, METHOD FOR DRIVING THE SAME, AND ELECTRONIC MACHINE

(75) Inventors: Takashi TOYOOKA, Matsumoto-shi (JP); Hiroyuki Hosaka, Matsumoto-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/107,405

(22) Filed: Apr. 22, 2008

(30) Foreign Application Priority Data
May 16, 2007 (JP) 2007-130318

(51) Int. Cl. G09G 3/36

(52) U.S. Cl. 345/102

(57) ABSTRACT

An electro-optical device includes a liquid crystal drive unit that divides on a temporal axis one field into subfields and that, during the subfields, applies either an on-voltage or an off-voltage to picture elements of a liquid crystal display in accordance with gradation of the picture elements during the one field. A light source control unit sequentially switches the three light sources, and switches at least two of the three light sources at a switching period that is shorter than a time duration required to exhibit, in the picture elements during the one field, gradation of each color corresponding to each of the at least two of the three light sources.

### BACKGROUND

1. Technical Field

The present invention relates to an electro-optical device driven by a so-called color sequential drive system, a method for driving the same, and electronic machines.

2. Related Art

Conventionally, a projector or the like driven by a so-called color sequential drive system (a field sequential system) by use of a solid-state light source such as an LD or an LED has been known. This color sequential drive system is a drive system in which an image is displayed by switching among illuminant colors temporally, and respective color components projected onto a retina are mixed by an integrating function of human eye to be sensed in full color. This drive system has been known as a system in which, when an eye is moved, respective color components are not mixed, which brings about a color breakup phenomenon.

In a case in which color sequential driving is carried out in a single-panel liquid crystal projector, considering the effect of response time of liquid crystal, when a drive frequency is increased, the response time of the liquid crystal is not sufficiently fast, which causes interference between sequentially displayed illuminant colors in some cases. In response to such a problem, there has been proposed a technology of preventing interference of illuminant colors by limiting an emission period of a light source (for example, refer to Patent Document 1). In the technology described in Patent Document 1, lowering of brightness by limiting an emission period of a light source is suppressed by prolonging a period of voltage retention of the liquid crystal.

Meanwhile, in recent years, as a digital drive system for liquid crystal panels or the like, a subfield drive system has been proposed in which one field is divided into a plurality of subfields on a temporal axis, and an on-voltage or an off-voltage is applied to respective picture elements in the respective subfields in accordance with gradation (for example, refer to Patent Document 2). The subfield drive system is a drive system in which desired gradation is obtained as a temporal integrated value by repeatedly turning liquid crystal on and off temporally.

JP-A-2006-163358 is a first example of related art. JP-A-2001-100180 is a second example of related art.

The color breakup due to color sequential driving described above may be attenuated by increasing a switching frequency of illuminant colors. However, in the technology described in Patent Document 1 described above, in order to further increase a switching frequency of illuminant colors, it is necessary to shorten a period of voltage retention of liquid crystal, and it has been difficult to appropriately set both a drive frequency and an emission period. Further, in the technology described in Patent Document 2, color breakup due to color sequential driving is not taken into account.

### SUMMARY

An advantage of some aspects of the invention is to provide an electro-optical device capable of realizing satisfactory coloring and gradation characteristics by preventing color breakup due to color sequential driving, and to provide a method for driving the same and electronic machines.

According to an aspect of the invention, there is provided an electro-optical device having three light sources that respectively emit different colors, and a liquid crystal display, the electro-optical device displaying colors by temporally switching among three illuminant colors of the three light sources. The electro-optical device includes a liquid crystal drive unit that divides one field into a plurality of subfields on a temporal axis, the liquid crystal drive unit applying an on-voltage or an off-voltage to respective picture elements forming the liquid crystal display in the respective subfields in accordance with gradation. There is also provided a light source control unit that controls switching among the illuminant colors such that a switching period of the illuminant colors is shorter than a cycle in which liquid crystal in the picture elements exhibits gradation, with respect to at least two illuminant colors among the three illuminant colors.

The electro-optical device is a device that performs display in a full color image by use of a color sequential drive system in which illuminant colors are switched temporally. In this case, the liquid crystal drive unit divides one field into a plurality of subfields on a temporal axis, and applies an on-voltage or an off-voltage to the respective picture elements forming the liquid crystal display in the respective subfields in accordance with gradation. Further, the light source control unit switches the illuminant colors such that a switching period of the illuminant colors is shorter than a cycle in which the liquid crystal in the picture elements exhibits gradation, with respect to at least two illuminant colors among the three illuminant colors. In accordance therewith, it is possible to increase a switching frequency of the light sources without greatly increasing a drive frequency of the liquid crystal display (i.e., without shortening a period of voltage retention of the liquid crystal display). Namely, it is possible to effectively shorten a switching period of the illuminant colors without limiting an emission period of a light source. Accordingly, in accordance with the electro-optical device, it is possible to realize satisfactory coloring and gradation characteristics without lowering brightness by preventing color breakup due to color sequential driving.

In the electro-optical device, it is preferable that the liquid crystal drive unit sets patterns composed of the on-voltage or the off-voltage to be applied to the liquid crystal in order for the liquid crystal to exhibit gradation to be substantially the same for the illuminant colors. Thereby, it is possible to effectively prevent color breakup in an image to be displayed.

In a mode of the electro-optical device, the light source control unit changes a switching period of the illuminant colors on the basis of an image signal to be inputted. It is preferable that the light source control unit determines an average gradation value of each color on the basis of the image signal, and changes a switching period of the illuminant colors in accordance with the average gradation value. Namely, it is possible to change a switching period of the illuminant colors on the basis of chromatic balance in an image. Thereby, it is possible to prevent color breakup from occurring while effectively restraining deterioration in display due to the liquid crystal having a slow response time.

In another mode of the electro-optical device, the liquid crystal drive unit simultaneously supplies signals to all scanning lines of the liquid crystal display at substantially the same timing. Thereby, it is possible to execute irradiation with a light source corresponding to a writing time of the liquid crystal display. Accordingly, it is possible to effectively prevent unevenness in a screen, and the like, which makes it possible to improve display quality.

The electro-optical device may be exemplarily applied to various electronic machines.

According to another aspect of the invention, a method for driving an electro-optical device that displays colors by temporally switching among at least three different illuminant colors, the method includes driving a liquid crystal so as to divide one field into a plurality of subfields on a temporal axis, and to apply an on-voltage or an off-voltage to respective picture elements forming the liquid crystal display in the respective subfields in accordance with gradation, and controlling light sources so as to control switching of the illuminant colors such that a switching period of the illuminant colors is shorter than a cycle in which liquid crystal in the picture elements exhibits gradation, with respect to at least two illuminant colors among the three illuminant colors. In accordance with the method for driving the electro-optical device as well, it is possible to realize satisfactory coloring and gradation characteristics without lowering brightness by preventing color breakup due to color sequential driving.

### BRIEF DESCRIPTION OF THE DRAWINGS

FIG. 1 is a block diagram showing a schematic structure of a liquid crystal projector to which an electro-optical device according to an embodiment is applied.

FIG. 2 is a block diagram showing a schematic structure of a driving circuit of the liquid crystal projector.

FIG. 3 is a diagram showing a schematic structure of a scanning line driving circuit, a data line driving circuit, and a liquid crystal panel.

FIG. 4 is a diagram showing a schematic structure of a picture element.

FIGS. 5A and 5B are diagrams for explanation of a scan method of scanning lines according to the present embodiment.

FIGS. 6A and 6B are diagrams showing a vertical scanning signal and start pulses used in the embodiment.

FIGS. 7A, 7B, and 7C show timing charts of respective control signals used in the embodiment.

FIGS. 8A, 8B, and 8C are charts showing an example of changes in charging voltage and transmittance in a liquid crystal.

FIG. 9 is a graph to aid in concrete explanation of a light source control method according to a first embodiment.

FIG. 10 is a graph to aid in concrete explanation of a light source control method according to a comparative example 1.

FIGS. 11A and 11B are charts showing an example of field writing.

FIG. 12 is a block diagram showing a schematic structure of a driving circuit according to a second embodiment.

FIG. 13 is a graph to aid in concrete explanation of a light source control method according to the second embodiment.

FIG. 14 is a graph to aid in concrete explanation of a light source control method according to a comparative example 2.

### DESCRIPTION OF EXEMPLARY EMBODIMENTS

Hereinafter, an exemplary embodiment of the present invention will be described with reference to the accompanying drawings.

### Device Structure

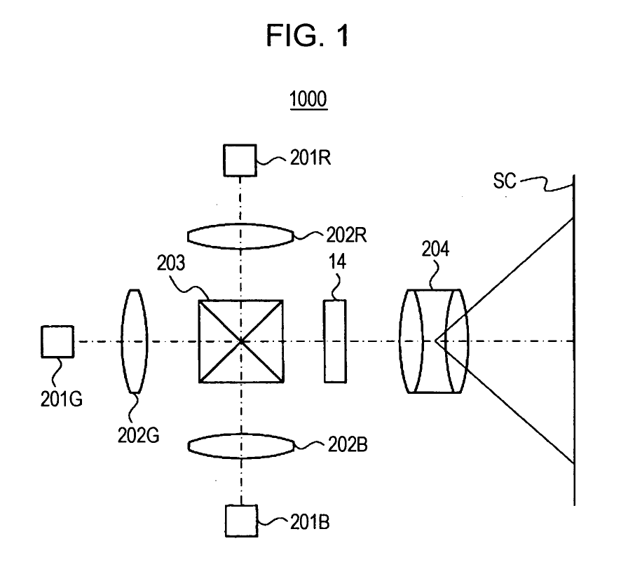

FIG. 1 is a block diagram showing a schematic structure of a liquid crystal projector 1000 to which an electro-optical device according to the present embodiment is applied. The liquid crystal projector 1000 includes a red light source 201R (hereinafter called “R light source”), a green light source 201G (hereinafter called “G light source”), a blue light source 201B (hereinafter called “B light source”), relay lenses 202R, 202G, and 202B, a cross prism 203, a liquid crystal panel 14, and a projection optical system 204.

The liquid crystal projector 1000 is configured as a projection liquid crystal device in a single-panel system using the liquid crystal panel 14 functioning as a liquid crystal light valve. Further, the liquid crystal projector 1000 performs display in full color by use of a color sequential drive system in which illuminant colors are temporally switched to display an image.

The R light source 201R is a solid-state light source that emits red light, the G light source 201G is a solid-state light source that emits green light, and the B light source 201B is a solid-state light source that emits blue light. The R light source 201R, the G light source 201G, and the B light source 201B are composed of, for example, LEDs (Light-Emitting Diodes) or the like. Light emitted by the R light source 201R, the G light source 201G, and the B light source 201B (hereinafter simply called “light sources” when there is no distinction) is made incident to the cross prism 203 through the relay lenses 202R, 202G, and 202B respectively. The cross prism 203 reflects the respective red light, green light, and blue light made incident through the relay lenses 202R, 202G, and 202B to be made incident to the liquid crystal panel 14.

The liquid crystal panel 14 is made such that liquid crystal which is an electro-optical substance is hermetically sealed between a pair of transparent glass substrates. The liquid crystal panel 14 functions as a so-called liquid crystal light valve, to modulate an incident light in response to a supplied image signal. The light modulated by the liquid crystal panel 14 is enlarged to be projected by the projection optical system 204, to form a large screen image on a screen SC. Note that the details of the liquid crystal panel 14 will be described later.

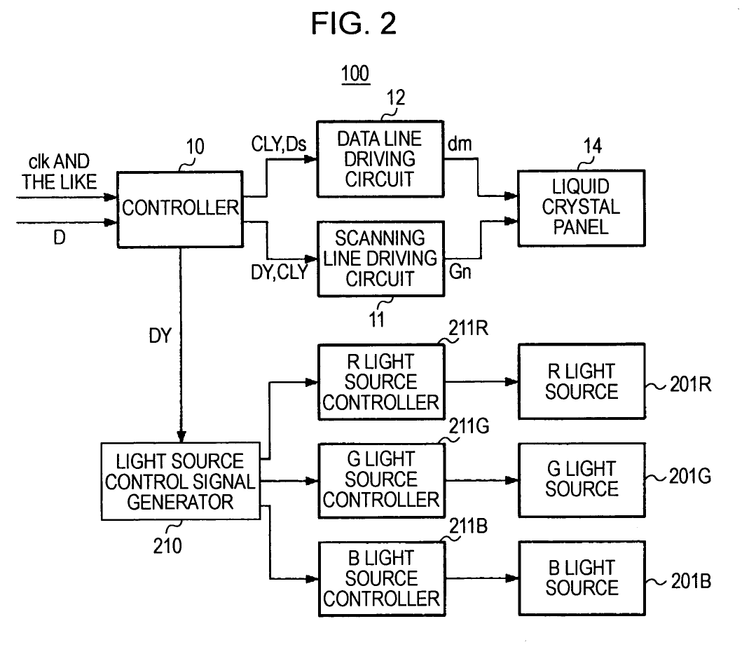

Next, a driving circuit that drives the light sources of the liquid crystal projector 1000 and the liquid crystal panel 14 described above will be described with reference to FIG. 2. FIG. 2 is a block diagram showing a schematic structure of a driving circuit 100 of the liquid crystal projector 1000.

The driving circuit 100 mainly includes a controller 10, a scanning line driving circuit 11, a data line driving circuit 12, a light source control signal generator 210, an R light source controller 211R, a G light source controller 211G, and a B light source controller 211B. The driving circuit 100 is mounted in the liquid crystal projector 1000, and drives the light sources to control an image projected by the liquid crystal projector 1000.

The controller 10 acquires a clock signal clk, an image signal D, and the like, and generates start pulses DY, a scanning side transfer clock CLY, a data transfer clock CLX, a data signal Ds, and the like on the basis of the clock signal clk, the image signal D, and the like, and supplies the start pulses DY, the scanning side transfer clock CLY, the data transfer clock CLX, the data signal Ds, and the like to the scanning line driving circuit 11 and the data line driving circuit 12. The scanning line driving circuit 11 supplies scanning signals Gn to the liquid crystal panel 14 (the scanning line driving circuit 11 supplies “G1, G2, G3, . . . , and Gn” to n scanning lines). Further, the data line driving circuit 12 supplies data signals dm to the liquid crystal panel 14 (the data line driving circuit 12 supplies “d1, d2, d3, . . . , and dm” to m data lines).

Further, the controller 10 supplies the start pulses DY to the light source control signal generator 210. The light source control signal generator 210 generates light source control signals to regulate a switching period of light sources or the like on the basis of the start pulses DY. The R light source controller 211R, the G light source controller 211G, and the B light source controller 211B respectively acquire light source control signals from the light source control signal generator 210, and drive the R light source 201R, the G light source 201G, and the B light source 201B on the basis of these signals.

Note that the driving circuit 100 composed of the controller 10, the light source control signal generator 210, and the like functions as an electro-optical device in the invention. More precisely, the driving circuit 100 operates as a liquid crystal driver and a light source controller.

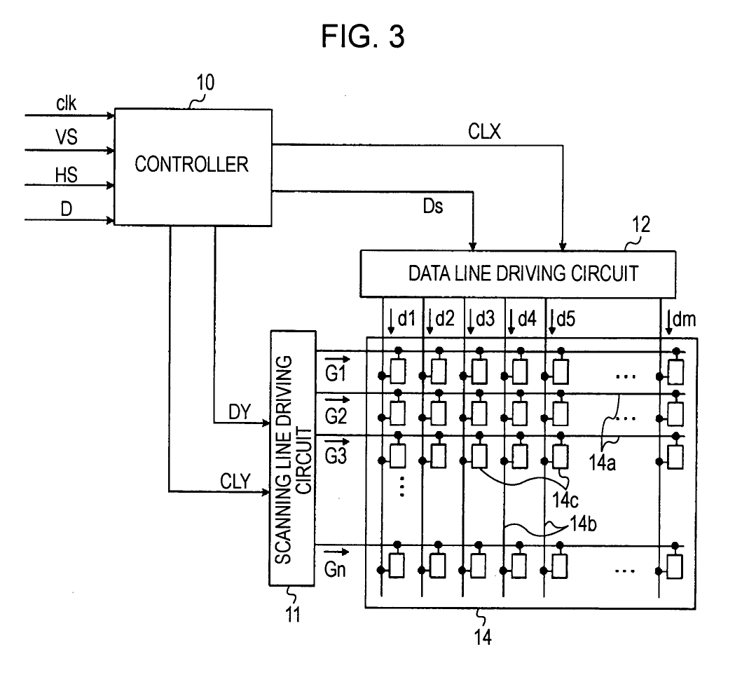

Next, the structures of the scanning line driving circuit 11, the data line driving circuit 12, and the liquid crystal panel 14 described above will be more precisely described with reference to FIG. 3.

The controller 10 acquires a clock signal clk, a vertical scanning signal VS, a horizontal scanning signal HS, and an image signal D from the outside. Then, the controller 10 generates start pulses DY, a scanning side transfer clock CLY, a data transfer clock CLX, and a binary data signal Ds on the basis of these acquired signals. The start pulses DY are pulse signals to be outputted at timings at which scanning is started with respect to a scanning side (Y side). A scanning side transfer clock CLY is a signal to regulate horizontal scanning at the scanning side (Y side). A data transfer clock CLX is a signal to regulate a timing of transferring data to the data line driving circuit 12. A data signal Ds is data corresponding to an image signal D, and is data indicating a high level or a low level for setting picture elements 14c to be in an on-state or an off-state every subfield period. Note that various other signals are inputted to and outputted from the controller 10, the scanning line driving circuit 11, and the data line driving circuit 12. However, descriptions of signals having no specific connection with the embodiment will be omitted.

The scanning line driving circuit 11 acquires start pulses DY and a scanning side transfer clock CLY from the controller 10, and outputs scanning signals G1, G2, G3, . . . , and Gn to scanning lines 14a of the liquid crystal panel 14. More precisely, the scanning line driving circuit 11 transfers the start pulses DY supplied from the controller 10 in accordance with the scanning side transfer clock CLY, and supplies the start pulses DY as the scanning signals G1, G2, G3, . . . , and Gn sequentially exclusively to each of the scanning lines 14a.

The data line driving circuit 12 acquires the data transfer clock CLX and the data signal Ds from the controller 10, and outputs data signals d1, d2, d3, . . . , and dm to the data lines 14b of the liquid crystal panel 14. More precisely, the data line driving circuit 12 sequentially latches m binary signals Ds corresponding to a number of the data lines 14b for a certain horizontal scanning period. Thereafter, the data line driving circuit 12 simultaneously supplies the latched m binary signals Ds as the data signals d1, d2, d3, . . . , and dm to the corresponding data lines 14b for the following horizontal scanning period.

The liquid crystal panel 14 is, as described above, composed of liquid crystal (LCD), and is a liquid crystal display that displays image signals and the like by having a voltage applied thereto. More precisely, the liquid crystal panel 14 includes the scanning lines 14a, the data lines 14b, and the picture elements 14c. In further detail, in the liquid crystal panel 14, the n scanning lines 14a are formed so as to extend along an X (a row) direction in FIG. 3, and the m data lines 14b are formed so as to extend along a Y (a column) direction. Then, the picture elements 14c are arranged at positions corresponding to the intersections of the scanning lines 14a and the data lines 14b, and are thus arrayed in a matrix form.

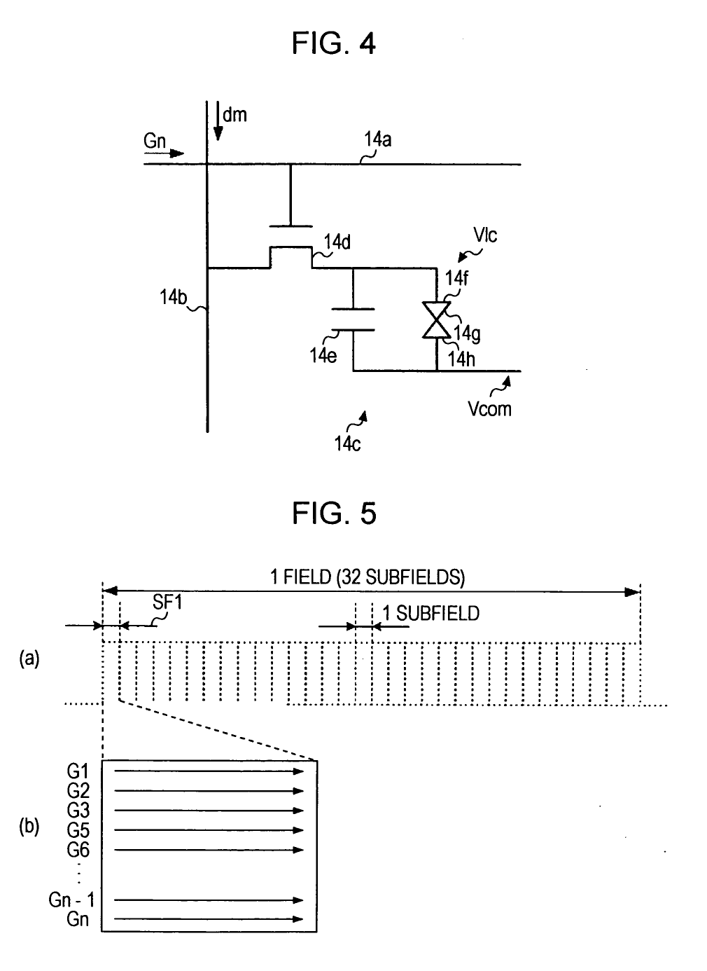

The detailed structure of the picture element 14c will be described with reference to FIG. 4. The picture element 14c mainly includes a transistor 14d, a storage capacitor 14e, a picture electrode 14f, a liquid crystal element 14g, and a counter electrode 14h.

In the structure shown in FIG. 4, a gate, a source, and a drain of the transistor 14d serving as a switching element are respectively connected to the scanning line 14a, the data line 14b, and the picture electrode 14f. Then, the liquid crystal element 14g serving as an electro-optical material is sandwiched between the picture electrode 14f and the counter electrode 14h to form a liquid crystal layer. Where the counter electrode 14h is a transparent electrode formed on an entire surface of a counter substrate so as to face the picture electrode 14f. Further, a counter electrode voltage Vcom is to be applied to the counter electrode 14h. Moreover, the storage capacitor 14e is formed between the picture electrode 14f and the counter electrode 14h, and stores electric charge along with the electrodes sandwiching the liquid crystal layer. Note that a voltage Vlc in FIG. 4 corresponds to a voltage charged to the picture element 14c (hereinafter called “charged voltage Vlc”).

The scanning signals G1, G2, . . . , Gn (hereinafter, simply called “Gn” collectively) are supplied to the scanning lines 14a corresponding thereto from the scanning line driving circuit 11 described above. The transistors 14d forming the picture elements of the respective lines are brought into conduction states by the respective scanning signals, and thereby, the data signals d1, d2, . . . , and dm (hereinafter, simply called “dm” collectively) are supplied to the respective data lines 14b from the data line driving circuit 12 described above. Then, the orientations of the molecules of the liquid crystal element 14g are changed in accordance with a difference in potential between the picture electrodes 14f and the counter electrodes 14h, which modulates the light, and allows gradation display to be performed.

### Method for Driving Liquid Crystal Panel

Next, a method for driving the liquid crystal panel 14 according to the embodiment will be described with reference to FIGS. 5 to 8. In the embodiment, an image is displayed on the basis of a subfield drive system in which one field is divided into a plurality of subfields on a temporal axis, and an on-voltage or an off-voltage is applied to respective picture elements in the respective subfields in accordance with gradation. Namely, writing is sequentially executed to all picture elements for one subfield period at one of binary voltages corresponding to an on-voltage or an off-voltage, and this process is repeatedly executed in all the subfields making up one field, which determines brightness of the field.

Note that explanation will be made assuming that a display mode in the liquid crystal panel 14 is normally white, and black display is carried out in a state in which a voltage is applied to a picture element (on-state), and white display is carried out in a state in which a voltage is not applied to a picture element (off-state). Further, a case in which one field is divided into 32 subfields will be described as an example.

FIGS. 5A and 5B are diagrams for explanation of a scan method of the scanning lines 14a according to the embodiment. FIG. 5A shows one field and 32 subfields making up the field, and FIG. 5B shows the scanning lines 14a scanned in a subfield SF1, and the scanning signals G1, G2, G3, . . . , and Gn. As shown in FIG. 5B, scanning with respect to all the scanning lines 14a is carried out in one subfield.

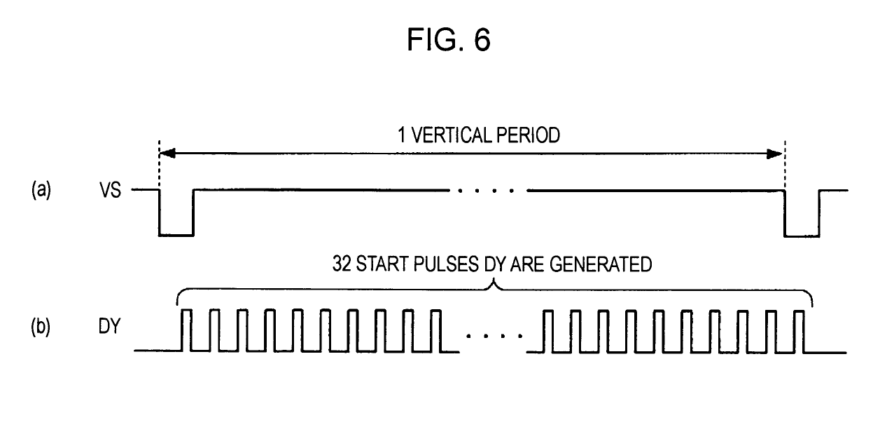

FIGS. 6A and 6B are diagrams showing a vertical scanning signal VS and start pulses DY used in the embodiment. FIG. 6A shows the vertical scanning signal VS, and FIG. 6B shows start pulses DY. As shown in FIG. 6B, the controller 10 generates the 32 start pulses DY for one vertical period (one field period).

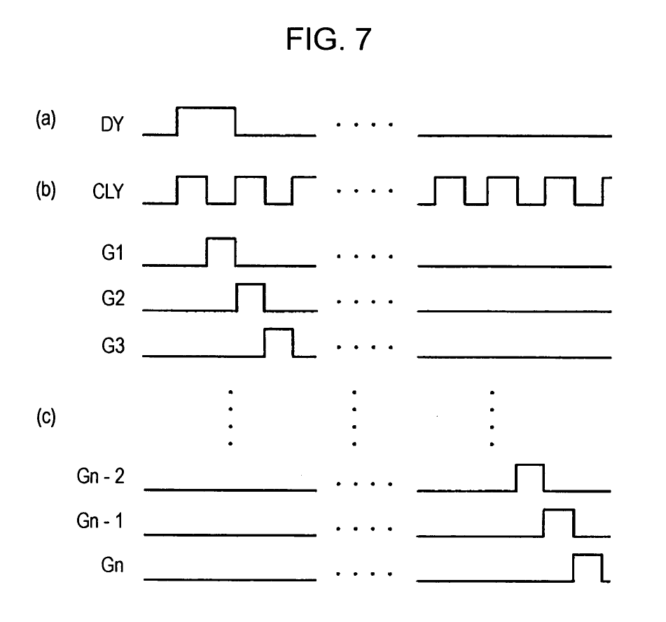

Next, FIGS. 7A, 7B, and 7C show timing charts of the respective control signals used in the embodiment. FIG. 7A shows the start pulses DY, FIG. 7B shows the scanning side transfer clock CLY, and FIG. 7C shows the scanning signals G1, G2, G3, . . . , and Gn. As shown in FIG. 7C, in synchronization with the scanning side transfer clock CLY, the start pulses DY are outputted as the scanning signals G1, G2, G3, . . . , and Gn sequentially exclusively to the respective scanning lines 14a.

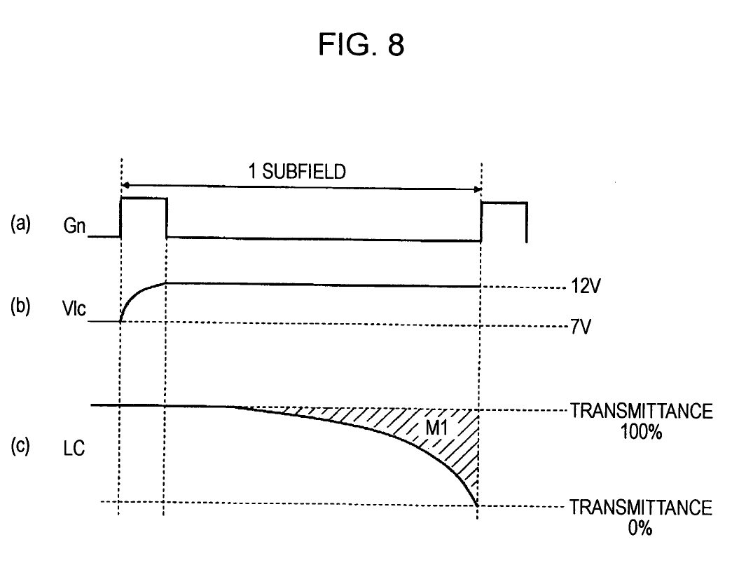

FIGS. 8A, 8B, and 8C show a charging voltage Vlc and transmittance LC when driving as shown in FIG. 7 is carried out. Note that a case in which a voltage of a data signal dm is “12V”, and a counter electrode voltage Vcom is “7V” will be described here as an example.

FIG. 8A shows a scanning signal Gn in one subfield, FIG. 8B shows the charging voltage Vlc of the picture element 14c, and FIG. 8C shows the transmittance LC of the liquid crystal element 14g. In this case, 12V of a data signal dm is charged to the picture element 14c (refer to FIG. 8B), and the liquid crystal element 14g makes a response corresponding to the applied voltage of 12V (refer to FIG. 8C). More precisely, the transmittance falls to 0% at the end of one subfield. In this case, the picture element is darkened by an amount of an area M1 (a voltage integral value) in FIG. 8C.

### Light Source Control Method

Hereinafter, a light source control method according to the embodiment of the invention will be described in detail.

### First Embodiment

In a first embodiment, switching of illuminant colors is controlled such that a switching period of illuminant colors is shorter than a cycle in which the liquid crystal elements 14g of the picture elements 14c exhibit gradation. Namely, in the first embodiment, subfields using the same illuminant color are not displayed continuously, but a subfield is switched to another subfield using a different illuminant color before gradation is exhibited temporally. This switching corresponds to the effect that gradation is exhibited by making light sources emit light at appropriate timings while restraining the liquid crystal panel 14 from being driven as much as possible. Thereby, it possible to prevent color breakup due to color sequential driving from occurring, and to realize satisfactory coloring and gradation characteristics.

Note that such switching control of illuminant colors is mainly executed by the light source control signal generator 210 in the driving circuit 100 described above. More precisely, the light source control signal generator 210 generates light source control signals to regulate a switching period of light sources on the basis of the start pulses DY supplied from the controller 10.

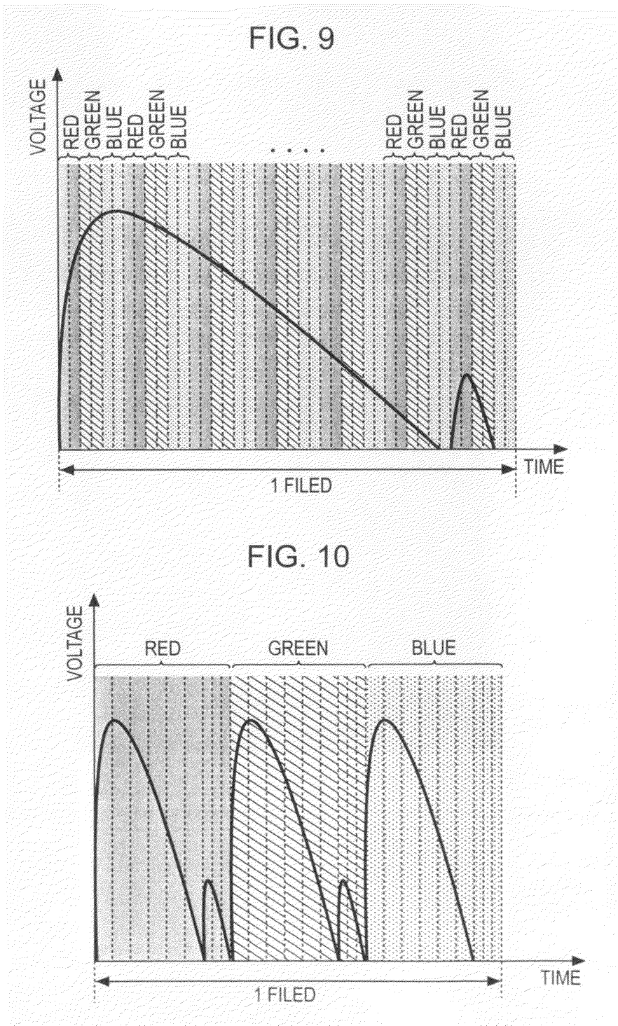

The light source control method according to the first embodiment will be described in detail with reference to FIG. 9. Note that, in FIG. 9, time is plotted along the abscissa and voltage of the liquid crystal element 14g (corresponding to the charging voltage Vlc described above) is plotted along the ordinate. Further, the solid line denotes an example of a response waveform of the liquid crystal panel 14, and the broken lines (a plurality of broken lines drawn vertically in FIG. 9) denote generating timings of the start pulses DY. Namely, a space between two broken lines corresponds to one subfield period. Moreover, in FIG. 9, the illuminant colors are represented by shaded regions, and red light, green light, and blue light are respectively represented by different shadings.

In the first embodiment, as shown by the solid line and the broken lines in FIG. 9, the colors of the illuminant colors are switched sequentially before gradation is exhibited temporally (this time generally corresponds to one field period in FIG. 9). In other words, in the first embodiment, subfields using the same illuminant color are not continuously displayed for a certain time, but a subfield is switched to another subfield using a different illuminant color before gradation is exhibited temporally. More precisely, in this example, the light source control signal generator 210 switches between the light sources substantially every second start pulse DY (i.e., every second subfield). Namely, the light source control signal generator 210 sequentially switches the R light source 201R, the G light source 201G, and the B light source 201B on and off substantially every second start pulse DY. Such a switching period of the illuminant colors is shorter than a cycle in which the liquid crystal elements 14g exhibit gradation (that is substantially one field period).

Note that this is not limited to a case where the illuminant colors are switched every second subfield. Namely, provided that a switching period of the illuminant colors is shorter than a cycle in which the liquid crystal elements 14g exhibit gradation temporally, this is not limited to a case where the illuminant colors are switched every second subfield.

Next, a light source control method according to a comparative example (hereinafter called “comparative example 1”) will be described with reference to FIG. 10. In FIG. 10, time is plotted along the abscissa and voltage of the liquid crystal element 14g is plotted along the ordinate. Further, the solid line denotes an example of a response waveform of the liquid crystal panel 14, and the broken lines denote generating timings of the start pulses DY. Moreover, in FIG. 10, the illuminant colors are represented by shaded regions, and red light, green light, and blue light are respectively represented by different shadings. Note that it is assumed that, in the example shown in FIG. 10 and the example shown in FIG. 9 described above, the image signals D to be inputted to the driving circuits 100 are substantially the same. Therefore, a waveform in which the response waveform, which is shown in FIG. 9, of the liquid crystal panel 14 is rearranged by the illuminant colors is substantially the same as the response waveform shown in FIG. 10.

In the comparative example 1, as shown in the shaded regions of FIG. 10, the illuminant colors are switched in cycles corresponding to approximately “⅓” of one field. Namely, in the comparative example 1, the illuminant colors are switched in predetermined cycles with disregard to a cycle in which the liquid crystal elements 14g of the picture elements 14c exhibit gradation, and the like. Therefore, in the comparative example 1, subfields using the same illuminant color are continuously displayed for a certain time. More precisely, the same illuminant color is used continuously for a period of 3 subfields or more.

Here, the light source control method according to the first embodiment and the light source control method according to the comparative example 1 are compared with one another. In the first embodiment, differently from the comparative example 1, the illuminant colors are not switched in predetermined cycles, but the illuminant colors are switched before gradation is exhibited temporally. Namely, in the light source control method according to the first embodiment, gradation is exhibited by making the light sources emit light at appropriate timings while restraining the liquid crystal panel 14 from being driven as much as possible. Accordingly, in accordance with the first embodiment, it is possible to increase a switching frequency of the light sources without greatly increasing a drive frequency of the liquid crystal panel 14 (i.e., without shortening a period of voltage retention of the liquid crystal panel 14). Namely, it is possible to effectively shorten a switching period of the illuminant colors without limiting an emission period of a light source. Accordingly, in accordance with the light source control method according to the first embodiment, it is possible to realize satisfactory coloring and gradation characteristics without lowering brightness by preventing color breakup due to color sequential driving.

Note that it is preferable that patterns (hereinafter called “pulse codes” as well) composed of on-voltages and off-voltages to be applied to the liquid crystal element 14g in order for the liquid crystal element 14g to exhibit gradation, which are used in one subfield, are set to be substantially the same in the respective colors of the illuminant colors. Namely, it is preferable to use pulse codes having similar waveforms as pulse codes of color components in the respective colors in consideration of liquid crystal responses. The reason for this is to effectively restrain breaking caused in an image to be displayed.

Further, it is preferable to set a timing of switching the light sources in consideration of a time from generation of the start pulses DY until the liquid crystal element 14g makes a response. Thereby, the R light source 201R, the G light source 201G, and the B light source 201B are repeatedly turned on and off alternately.

Moreover, it is preferable to supply the scanning signals Gn at substantially the same timing to all the scanning lines 14a of the liquid crystal panel 14. Namely, it is preferable to simultaneously supply the scanning signals Gn to all the scanning lines 14a. Namely, it is preferable to execute so-called field writing onto the liquid crystal panel 14. The reason for this is to execute irradiation with a light source for a corresponding writing time onto the liquid crystal panel 14.

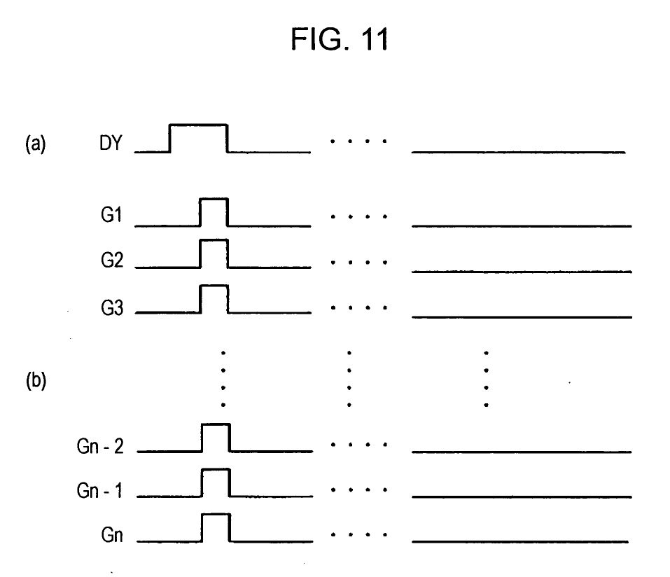

FIGS. 11A and 11B are charts showing an example of the field writing. FIG. 11A shows the start pulse DY, and FIG. 11B shows the scanning signals G1, G2, G3, . . . , and Gn when the field writing is executed. As shown in FIG. 11B, it can be understood that the scanning signals G1, G2, G3, . . . , and Gn are simultaneously outputted at the timing of the start pulse DY. By executing such field writing, it is possible to execute irradiation with a light source for a corresponding writing time onto the liquid crystal panel 14. Thereby, it is possible to effectively restrain unevenness in a screen, and the like, which makes it possible to improve display quality.

### Second Embodiment

Next, a light source control method according to a second embodiment will be described. In the second embodiment as well, in the same way as in the first embodiment, switching of the illuminant colors is controlled such that a switching period of the illuminant colors is shorter than a cycle in which the liquid crystal elements 14g exhibit gradation. However, the second embodiment is different from the first embodiment from the view point that a switching period of the illuminant colors is changed on the basis of an image signal D to be inputted. More precisely, in the second embodiment, an average gradation value of each color is determined on the basis of an image signal D, and a switching period of the illuminant colors is changed in accordance with the average gradation value. Namely, in the second embodiment, a switching period of the illuminant colors is changed on the basis of chromatic balance in an image. Thereby, it is possible to prevent color breakup from occurring while effectively preventing deterioration of display due to the liquid crystal element 14g having a slow response time.

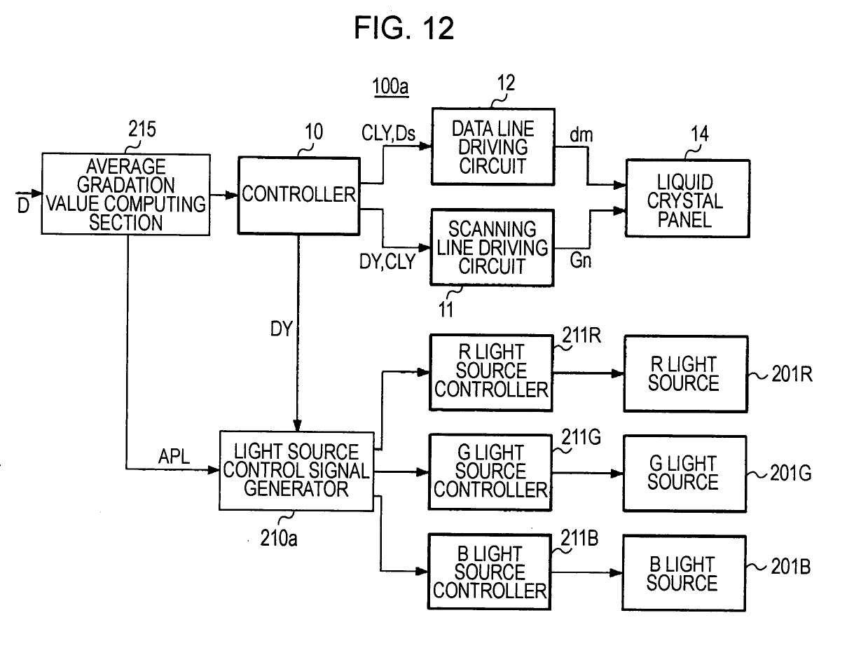

FIG. 12 is a block diagram showing a schematic structure of a driving circuit 100a that executes the light source control according to the second embodiment. The driving circuit 100a mainly includes the controller 10, the scanning line driving circuit 11, the data line driving circuit 12, a light source control signal generator 210a, the R light source controller 211R, the G light source controller 211G, the B light source controller 211B, and an average gradation value computing section 215. The driving circuit 100a is mounted in the liquid crystal projector 1000 described above or the like, and controls the liquid crystal projector 1000. Note that, here, structural members and signals which are the same as those in the driving circuit 100 (refer to FIG. 2) described above are denoted by the same reference numerals, and descriptions thereof will be omitted.

The average gradation value computing section 215 is disposed at a stage prior to the controller 10, and analyzes an image signal D to be inputted. More precisely, the average gradation value computing section 215 determines an average gradation value of each color (each of R, G, and B) with respect to all the picture elements in a screen on the basis of the inputted image signal D. Then, the average gradation value computing section 215 outputs a signal APL corresponding to a determined average gradation value to the light source control signal generator 210a. Note that the image signal D itself is inputted to the controller 10.

The light source control signal generator 210a generates light source control signals to regulate a switching period of light sources or the like on the basis of the signal APL supplied from the average gradation value computing section 215 and start pulses DY supplied from the controller 10. More precisely, the light source control signal generator 210a changes a switching period of the light sources on the basis of the signal APL corresponding to an average gradation value, i.e., changes a speed of switching the light sources. In further detail, the light source control signal generator 210a determines whether there is a deviation in average gradation value (chromatic balance in an image), and changes a switching period on this basis.

In more detail, when there is a large deviation in average gradation value for each color, the light source control signal generator 210a varies a switching period of the illuminant colors in an image-adaptive manner. For example, when there is a large deviation in average gradation value, the light source control signal generator 210a prolongs a switching period of the illuminant colors. This is because, when there is a deviation in average gradation value, an amount of variations at the time of switching among subfields of each color component increases, which brings about a possibility that the liquid crystal element 14g cannot necessarily respond. In contrast thereto, when it is determined that a deviation in average gradation value is small, the light source control signal generator 210a shortens a switching period of the illuminant colors. Namely, the light source control signal generator 210a switches the illuminant colors at a relatively high speed.

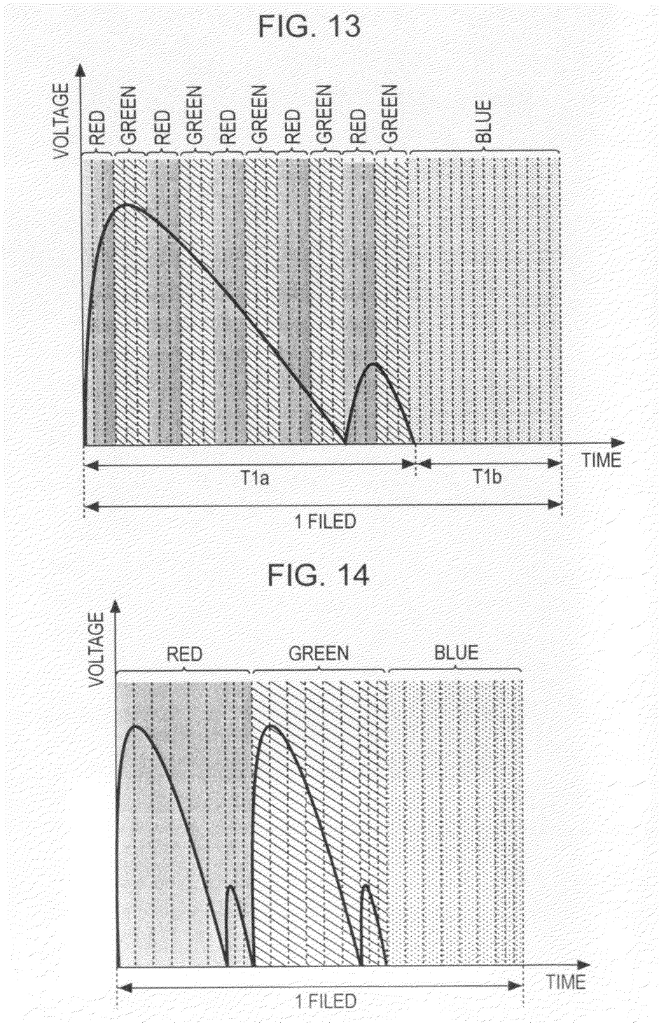

Next, the light control method according to the second embodiment will be described with reference to FIG. 13. Note that, in FIG. 13, time is plotted along the abscissa and voltage of the liquid crystal element 14g (corresponding to the charging voltage Vlc described above) is plotted along the ordinate. Further, the solid line denotes an example of a response waveform of the liquid crystal panel 14, and the broken lines denote generating timings of the start pulses DY. Moreover, in FIG. 13, the illuminant colors are represented by shaded regions, and red light, green light, and blue light are respectively represented by different shadings.

In an example shown in FIG. 13, it is assumed that there is very little information on blue (B) in the image signal D to be inputted to the driving circuit 100a. Namely, it is assumed that an image with no bluish tone (a strong yellow image) is inputted. In this case, a deviation is caused in an average gradation value (signal APL) determined by the average gradation value computing section 215. Accordingly, the light source control signal generator 210a determines that there is a large deviation in the average gradation value for each color, and changes a switching period of the illuminant colors in an image-adaptive manner. More precisely, the light source control signal generator 210a switches between the illuminant colors as illustrated by the shaded regions of FIG. 13.

In this case, as illustrated by the solid line in FIG. 13, the light source control signal generator 210a executes switching between the two colors of red light and green light during a period T1a in which the liquid crystal elements 14g of the picture elements 14c substantially exhibit gradation. Namely, the light source control signal generator 210a repeatedly executes switching of the two colors of red light and green light before gradation is exhibited temporally. The reason why switching is executed between the two colors of red light and green light is that there is very little information on blue (B) in the input image signal D. In more detail, the light source control signal generator 213a executes switching in a cycle of the three start pulses DY (i.e., a cycle corresponding to an amount of three subfields) with respect to red light and green light. In contrast thereto, during a period T1b after the liquid crystal elements 14g of the picture elements 14c exhibit gradation, the light source control signal generator 210a continues to retain blue light as an illuminant color (namely, with respect to blue light, switching to another color is not executed after switching to blue light once in one field). Note that, because there is very little information on blue (B) in the image signal D, the liquid crystal panel 14 is not driven during the period T1b using blue light.

Note that, during the period T1a in FIG. 13, the method is not limited to that in which only the two colors of red light and green light are switched. During the period T1a in which the liquid crystal elements 14g exhibit gradation, switching of the illuminant colors may be carried out by using not only red light and green light, but also blue light.

A light source control method according to a comparative example (hereinafter called “comparative example 2”) will be described with reference to FIG. 14. In FIG. 14 also, time is plotted along the abscissa and voltage of the liquid crystal element 14g is plotted along the ordinate. Further, the solid line denotes an example of a response waveform of the liquid crystal panel 14, and the broken lines denote generating timings of the start pulses DY. Moreover, in FIG. 14, the illuminant colors are represented by shaded regions, and red light, green light, and blue light are respectively represented by different shadings. Note that it is assumed that, in the example shown in FIG. 14 and the example shown in FIG. 13 described above, the image signals D to be inputted to the driving circuits 100a are substantially the same. Namely, it is assumed that an image with no bluish tone (a strong yellow image) in which there is very little information on blue (B) is inputted.

In the comparative example 2, as shown in the shaded regions of FIG. 14, the illuminant colors are switched in cycles corresponding to approximately “⅓” of one field. Namely, in the comparative example 2, the colors of the illuminant colors are switched in predetermined cycles with disregard to a cycle in which the liquid crystal elements 14g of the picture elements 14c exhibit gradation, or the like. Therefore, in the comparative example 2, subfields using the same illuminant color are continuously displayed for a certain time. More precisely, the same illuminant color is used continuously for a period of 3 subfields or more.

The light source control method according to the second embodiment and the light source control method according to the comparative example 2 are compared with one another. In the second embodiment, differently from the comparative example 2, the illuminant colors are not switched in predetermined cycles, but the illuminant colors are switched before gradation is exhibited temporally. Namely, in the light source control method according to the second embodiment, gradation is exhibited by making the light sources emit light at appropriate timings while restraining the liquid crystal panel 14 from being driven as much as possible. Accordingly, in accordance with the second embodiment, it is possible to increase a switching frequency of the light sources without greatly increasing a drive frequency of the liquid crystal panel 14 (i.e., without shortening a period of voltage retention of the liquid crystal panel 14). Therefore, it is possible to effectively shorten a switching period of the illuminant colors without limiting an emission period of a light source.

In the light source control method according to the second embodiment, differently from the comparative example 2, a switching period of the illuminant colors is changed in accordance with a deviation in the average gradation value of the image signal D. Accordingly, in accordance with the second embodiment, it is possible to suppress deterioration in display due to the liquid crystal element 14g having a slow response time. As described above, in accordance with the second embodiment, it is possible to realize satisfactory coloring and gradation characteristics without lowering brightness by preventing color breakup due to color sequential driving.

Note that, when a switching timing of the light sources is changed on the basis of an average gradation value as described above, it is preferable to not only change a switching timing, but also to change a pulse code that drives the liquid crystal panel 14.

Further, when it is determined that there is a deviation in the average gradation value, it is preferable that gradation data is made into a histogram, and a correlation in frequency distributions thereof is taken into account. In this way, it is possible to precisely judge chromatic balance in an image.

### Modification

The invention may be applied to electronic machines (projectors and the like) configured so as to be capable of scanning even at an illumination side in accordance with scanning onto the liquid crystal panel 14. For example, the electronic machines may be configured such that a rotatable prism or the like is disposed in front of a liquid crystal panel, and light irradiated from light sources is made incident to the prism, and it is possible to change the position at which light is irradiated in the liquid crystal panel 14 by rotating the prism.

Further, in the above descriptions, the embodiments in which the invention is applied to the liquid crystal projector 1000 have been shown. However, the invention is not limited to the embodiments. Namely, the invention can be applied to other electronic machines as well.

The entire disclosure of Japanese Patent Application No. 2007-130318, filed May 16, 2007 is expressly incorporated by reference herein.

What is claimed is:

1. An electro-optical device comprising:
a liquid crystal display including picture elements;
three light sources that each emit a different color light;
a liquid crystal drive unit that divides on a temporal axis one field into subfields and that, during the subfields, applies either an on-voltage or an off-voltage to the picture elements of the liquid crystal display in accordance with gradation of the picture elements during the one field; and
a light source control unit that sequentially switches the three light sources, the light source control unit switching at least two of the three light sources at a switching period that is shorter than a time duration required to exhibit, in the picture elements during the one field, gradation of each color corresponding to each of the at least two of the three light sources.

2. The electro-optical device according to claim 1, wherein the liquid crystal drive unit sets patterns composed of the on-voltage or the off-voltage to be applied to the liquid crystal in order for the liquid crystal to exhibit gradation to be substantially the same in the respective illuminant colors.

3. The electro-optical device according to claim 1, wherein the light source control unit changes a switching period of the illuminant colors on the basis of an image signal to be inputted.

4. The electro-optical device according to claim 3, wherein the light source control unit determines an average gradation value of each illuminant color on the basis of the image signal, and changes a switching period of the illuminant colors in accordance with the average gradation value.

5. The electro-optical device according to claim 1, wherein the liquid crystal drive unit simultaneously supplies signals to all scanning lines of the liquid crystal display at substantially the same timing.

6. An electronic machine comprising the electro-optical device according to claim 1.

7. A method for driving an electro-optical device that includes picture elements and three light sources that each emit a different color light, the method comprising:
driving the electro-optical device so as to divide on a temporal axis one field into subfields and, during the subfields, applying either an on-voltage or an off-voltage to the picture elements of the electro-optical device in accordance with gradation of the picture elements during the one field; and
sequentially switching the three light sources, and switching at least two of the three light sources at a switching period that is shorter than a time duration required to exhibit, in the picture elements during the one field, gradation of each color corresponding to each of the at least two of the three light sources.
